(19) United States
(12) Patent Application Publication
(10) Pub. No.: US 2003/0107650 A1
(43) Pub. Date: Jun. 12, 2003

(54) Surveillance system with suspicious behavior detection

(75) Inventors: Antonio Colmenarez, Peekskill, NY (US); Srinivas Gutta, Buchanan, NY (US); Miroslav Trajkovic, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/014,228

(22) Filed: Dec. 11, 2001

(51) Int. Cl. H04N 7/18

(52) U.S. Cl. 348/150; 348/159

(57) ABSTRACT

A surveillance and security system for automatic detection and warning of detected events includes a unit for observing behavior in a predetermined area under surveillance, a unit for processing an output of observed behavior from the unit for observing, and a includes a pattern recognition module for recognizing whether the observed behavior is associated with predefined suspicious behaviors. Upon recognition that the observed behavior is suspicious, security is notified about the potential need for increased surveillance, or automatically increased surveillance can be provided. The pattern recognition module may include infrared heat profiles of persons, images of actually people, sequences of people manipulating shopping bags, tearing sounds of tearing different types of packaging such as paper and plastic for retail products. The observation of motion, which is related to behavior, is compared against a database of predefined acts. In addition to motion, images, for example, of groups of teenagers could be used to identify potentially higher security risks in the area under surveillance. A method of detecting suspicious behavior provides a process that may use hardware other than described in the system.

### BACKGROUND OF THE INVENTION

1. Field of the Invention

The present invention relates to security systems. More particularly, the present invention relates to surveillance systems.

2. Description of the Related Art

Conventional security and surveillance systems are based on limited event detection. For example, opening of doors windows, motion sensors on detecting intrusion of a premises, are common checkpoints for such security systems. At best, conventional system might use computer vision algorithms to detect motion or sound.

However, there is a need in the art for a security capable of the automatic detection of suspicious events (as well known in the surveillance community) and triggering of warning signals, etc.

### SUMMARY OF THE INVENTION

The present invention provides a system and a method providing automatic detection of suspicious behavioral patterns and triggering a warning system.

A system according to the present invention may comprise:

means for observing behavior in a predetermined area under surveillance;

means for processing an output of observed behavior from said means for observing, said means for processing including a pattern recognition means for recognizing whether said output of observed behavior is associated with predefined suspicious behaviors; and

means for notifying that said pattern recognition means recognizes at least one behavioral pattern associated with said set of predefined suspicious behaviors has been observed by said means for observing.

A method according to the present invention may comprise the steps of:

(a) observing behavior of a person in a predetermined area under surveillance;

(b) identifying whether the behavior observed in step (a) is associated with at least one of a plurality of predetermined suspicious behaviors by comparing the behavior observed with a plurality of predetermined behavioral patterns in a pattern recognition module;

(c) notifying security when the behavior observed in step (a) has been identified as being associated with at least one of the plurality of predetermined behavioral patterns in the recognition module.

The method may also include (d) increasing surveillance of said person whose behavior was observed in step (a) upon notification of security in step (c).

### BRIEF DESCRIPTION OF THE DRAWINGS

FIG. 1 illustrates an overview an embodiment of a system according to the present invention.

FIG. 2 provides details regarding the pattern recognition module shown in FIG. 1.

FIG. 3 is a flowchart providing an overview of a method according to the present invention.

FIG. 4 provides an optional step for the method shown in FIG. 3.

### DETAILED DESCRIPTION OF THE INVENTION

By way of illustration and not limitation, the following figures provide and their associated description provide an explanation of certain aspects of a system and method according to the present invention. It is understood by persons of ordinary skill in the art that there are variations to the illustrated system and method which are within the spirit of the invention and the scope of the appended claims, and as such the invention is not limited to the illustrations provided for explanatory purposes.

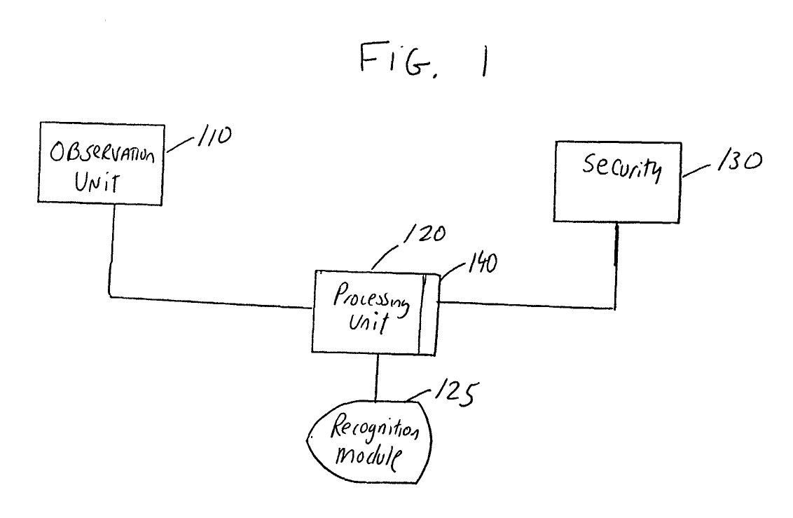

FIG. 1 is an overview of an embodiment of a system according to the present invention. An observation unit 110 is used to keep a predetermined area under surveillance. The observation unit 110 can be a video camera, an optical sensor, an infrared sensor which senses body heat as just a few of the many possible embodiments that the observation unit can comprise. The observation unit may also have the ability to sense sounds.

The observation unit communicates with a processing unit 120, which analyzes data from the observation unit to determine with any behavior patterns observed by the observation unit are associated with predetermined suspicious behavior stored in the pattern recognition module 125.

If there is a match recognized by the pattern recognition module 125 between an observed behavior and one of the predetermined suspicious behaviors, a notifying unit 140 notifies a security site 130. The security site, upon notification that suspicious behavior has been detected, may investigate the situation further by increasing surveillance of the person committing the behavior, and or notifying security personal to approach the area under surveillance.

It should be understood that the predetermined suspicious behaviors may be innocent actions common of, for example, lawful persons, so the notification and increased surveillance should be made with the realization that there may not have been unlawful activity committed. Innocent persons may react harshly to direct confrontation as to the security system indicating that they were doing something labeled suspicious.

The behavioral patterns stored in the recognition module can include tearing sounds consistent with tearing paper packaging or breaking plastic packaging, such as when a shoplifter rips open packing to take an item (the packaging often contains the security tag). For example, when someone in the aisle of a store tears open a box, this sound will be transmitted to the processing unit, and if the recognition module recognizes the sound as consistent with a potentially suspicious behavior (potential shoplifting) the notification unit will notify security that an individual in a particular area has been sensed as performing suspicious behavior. The security could be a person in front of a monitor, or it could be transmitted to a security guard via a portable terminal, pager, wireless communication device, etc. providing the information.

There can be severity levels associated with the detected suspicious behavior, which may be assigned to the detected behavior, and may be in conjunction with a particular area under surveillance. For example, in areas of a store where losses are higher in dollar value, such as jewelry, or in quantity of losses (which in aggregate may have a high dollar value) do, such as batteries, razors, compact discs, etc. the severity could be adjusted since the likelihood of shoplifting is greater in those areas of the store than, for example, the aisles with paper products.

Again, it should be noted that the detection of tearing sounds does not necessarily mean that something illegal has occurred, but merely that increased surveillance may be required. It would be best if, for example, a video of the aisle where the tearing sounds occurred was transmitted to security, so that someone can review whether someone is actually tearing opening packaging of an item for an illegal purposed, or merely ripping up a shopping list.

The processor means may have a storage area so that any observations which are recognized as suspicious behavior may be categorized by day, date, time, severity, etc. This would allow a security site to request the suspicious behavior “hits” for periodic review as well the real time reporting thereof.

Other types of behavior recognition, for example, can include recognizing when a group of people enter a store, separate in sub-groups or singles, and then leave, usually without approaching a register to purchase anything. One way the system could work would be an infrared sensor that recognizes body heat for each person entering the store.

Thus, a cluster or group of people entering the store can be identified, and the infrared sensors could monitor the difference in heat as the groups dispersed. Of course, it is not totally uncommon for a family to walk into a retail establishment and split up into different areas of jewelry, or in quantity of losses (which in aggregate may have a high dollar value) do, such as batteries, razors, compact discs, etc. the severity could be adjusted since the likelihood of shoplifting is greater in those areas of the store than, for example, the aisles with paper products.

Again, it should be noted that the detection of tearing sounds does not necessarily mean that something illegal has occurred, but merely that increased surveillance may be required. It would be best if, for example, a video of the aisle where the tearing sounds occurred was transmitted to security, so that someone can review whether someone is actually tearing opening packaging of an item for an illegal purposed, or merely ripping up a shopping list.

The processor means may have a storage area so that any observations which are recognized as suspicious behavior may be categorized by day, date, time, severity, etc. This would allow a security site to request the suspicious behavior “hits” for periodic review as well the real time reporting thereof.

Other types of behavior recognition, for example, can include recognizing when a group of people enter a store, separate in sub-groups or singles, and then leave, usually without approaching a register to purchase anything. One way the system could work would be an infrared sensor that recognizes body heat for each person entering the store.

Thus, a cluster or group of people entering the store can be identified, and the infrared sensors could monitor the difference in heat as the groups dispersed. Of course, it is not totally uncommon for a family to walk into a retail establishment and split up into different areas of head. These values are given for explanatory purposes only, and the subdivision of cells could range from 4 feet to 8 feet for example, when seeking to detect head movement. The width of the subdivided cells also could be smaller (shown by 230), so that the turning of the head in more easily identified. There would have to be a series of movements of the head monitored to distinguish between normal browsing and looking for security.

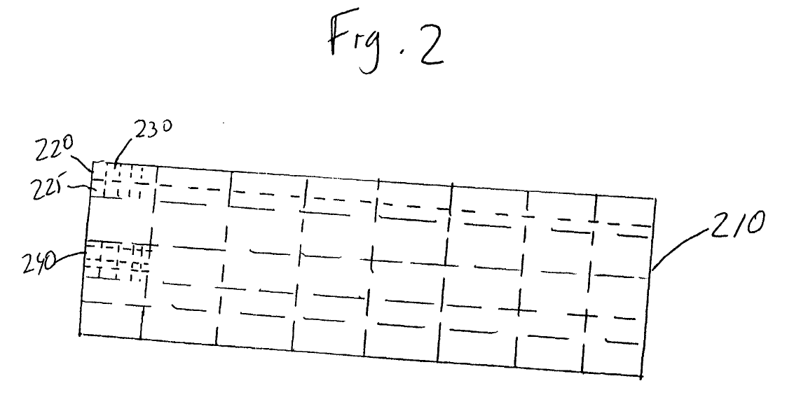

The use of sub-divided cells could be used to detect persons carrying handbags. As shown in FIG. 2, for example, at a height approximate where a handbag normally rests (i.e. approximately two and a half feet off the ground), there may be a number of subdivisions 240 to sense a bag next to a person's side. The manipulation of the bag vertically, horizontally, or diagonally could be the basis for indicating suspicious behavior. For a shopper to be reaching into a handbag while in the aisle of a store could possibly provide an indication that wrongdoing could be occurring. Again, it is also possible that a shopper merely reached into the bag for a tissue, and this manipulation is entirely innocent.

Another criteria used to possibly determine security breaches could be to identify children and young teenagers. Teenagers are often the most likely of all groups to attempt shoplifting, and if they can be identified by the system as having a higher risk, surveillance of them may be carried out at an increased level from the moment they enter the store. One way would be by determining the height of the patron.

Of course, there are many people who are shorter than young teenagers, and there are teenagers who tower over many adults in height, so identifying one's age based on height may not work well enough. It is possible however, that cameras could scan the image of patron walking into the store and the recognition module could compare them against images of people of different ages to identify someone in a particular age group, such as a teenager. If there are, for example, two or more teenagers, the system may notify security that an increased level of surveillance might be in order.

Yet another way that people often shoplift is to wear a thick coat and stuff items underneath to escape undetected. One possible way is the system can scan the persons entering the store, and compare against images of people wearing coats, or long sleeve shirts, or t-shirts, to identify whether someone is wearing a coat. This information could be cross-referenced with the outside temperature, time of year, date, etc. For example, if it is July, and a person is identified as wearing a winter coat, this could be one ground for notifying security that increased surveillance is recommended.

The sensors do not have to be placed solely in stationary areas of the area under surveillance. For example, shopping carts could have a pressure sensing means attached to the basket so that items placed within are sensed, and the output is transmitted to the processing unit via RF. The movement of the shopping carts could be tracked according to distance, amount of time that it has been since the cart entered the store, etc.

The system may be heuristic, in that movement of persons who actually are caught performing illegal or legitimately suspicious behavior are then loaded into the recognition module for future comparisons with subsequent patrons. Thus, the pattern recognition can be heuristic, and could also be updated with new models according to need.

The transmission between the sensors, the processing unit, the recognition module and security can be made by any of fiber optic, RF, copper wires, LAN, WAN, twisted pair, etc., any type of communication system according to need. The transmission between the sensors and the process could be one type of system, and the transmission between the processor and the security could comprise something different. It is desirable that the communication to security be made in real time in an attempt to increase surveillance of, and possibly apprehend, those committing criminal acts. The security, in turn, could send messages on pagers to security guards, with the aisle where there is suspicious behavior, and possible with an image of the person.

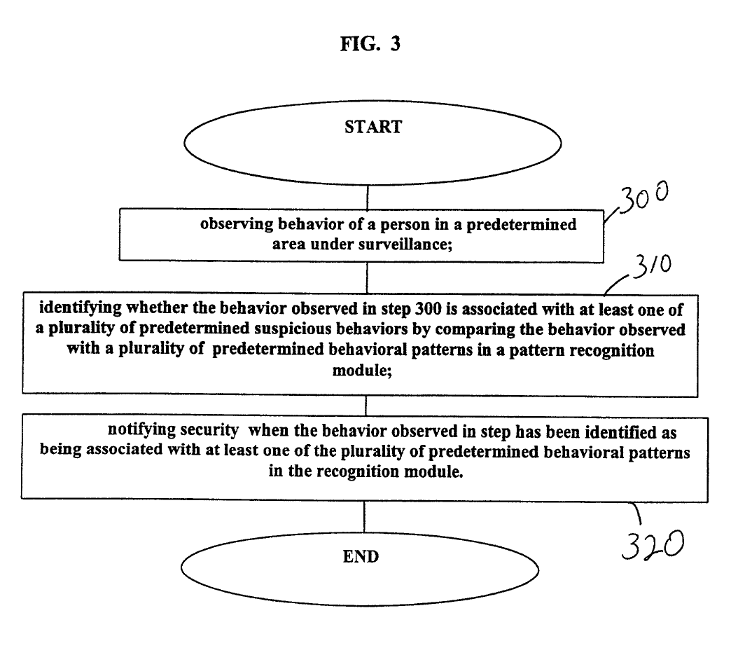

FIG. 3 provides an overview of a method according to the present invention.

At step 300, the behavior of a person in an area of surveillance is observed. It is understood that the area of surveillance could be anyplace where there is an amount of traffic of persons therethrough, and the invention should not be limited to an retail store. In addition, the area of surveillance can include an exterior and interior of a specific location within its perimeter. For example, a certain distance outside of the doors of a store might be monitored, and when it is recognized that a person or person have been standing outside for longer than a predetermined amount of time, there could be a notification to security to increase surveillance in that area.

At step 310, there is an identification as to whether the behavior observed in step 300 is associated with at least one of a plurality of predetermined suspicious behaviors by comparing the behavior observed with a plurality of behavioral patterns in a pattern recognition module.

The plurality of the behaviors in the pattern recognition module could be images as well as motion. For example, images of teenagers could be contained in the pattern recognition module, and the images of patrons entering the store could be scanned and compared to identify whether at least one person in the group appears to over a certain age. The motion of shoppers walking through the aisles, reaching in their bags (as previously discussed) could all be criteria contained in the pattern recognition module.

At step 320, security is notified when a behavior observed is recognized by the pattern recognition module as corresponding to a pattern in storage. Based on the type of recognition, and the degree, security may not only be notified, but may also receive a severity code about the seriousness of the perceived suspicious behavior.

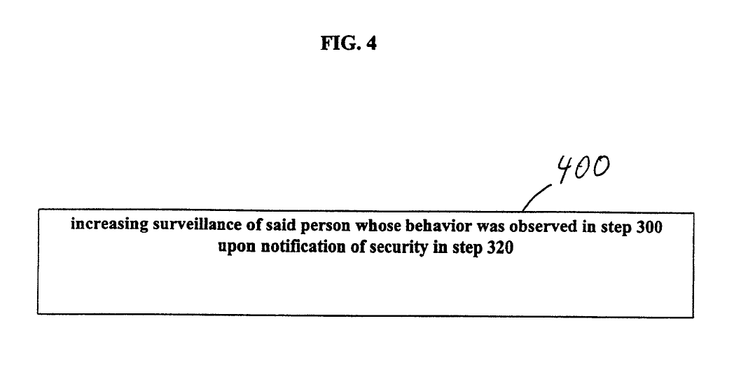

FIG. 4 includes an optional step 400, wherein the system may automatically increase surveillance, and not just notify a security area. For example, upon detection of suspicious behavior, the system may turn on several different cameras in that area, attempt to zoom in and focus on the person, and possibly repeat a code out loud. It is not uncommon in a retail store to hear phrases like “Security, code blue” which might mean there is a problem somewhere in the store, or could mean that security is trying to scare away potential shoplifters by making them wonder if they are the reason for the alert. There could also be an automatic description of a location of the store, something identifiable to employees but not to the shoppers.

Various modifications may be made by person of ordinary skill in the art, which is within the spirit of the invention and the scope of the appended claims. For example, the type of weather conditions sensed, the placement of the sensors, and the particular criteria used to increase or reduce posted speed limits can be modified.

What is claimed is:

1. A surveillance and security system for automatic detection and warning of detected events, said system comprising:
means for observing behavior in a predetermined area under surveillance;
means for processing an output of observed behavior from said means for observing, said means for processing including a pattern recognition means for recognizing whether said observed behavior is associated with predefined suspicious behaviors; and
means for notifying that said pattern recognition means recognizes at least one behavioral pattern associated with said set of predefined suspicious behaviors has been observed by said means for observing.

2. The system according to claim 1, wherein said means for observing includes cameras.

3. The system according to claim 1, wherein said means for observing includes sensors.

4. The system according to claim 3, wherein said sensors sense sounds.

5. The system according to claim 1, wherein said means for notifying includes warning signals communicated to a monitoring site.

6. The system according to claim 1, wherein said means for notifying includes a plurality of alert codes corresponding to a severity level of said at least one behavioral pattern associated with said set of predefined suspicious behaviors recognized by said pattern recognition means.

7. The system according to claim 1, wherein said area under surveillance includes a retail store, and said predefined suspicious behaviors recognized by said pattern recognition means includes recognizing a plurality of people entering the store as one group, said plurality subsequently separating into sub-groups in different portions of the store, and re-emerging as said one group when leaving the store.

8. The system according to claim 1, wherein said area under surveillance includes a retail store, and said predefined suspicious behaviors recognized by said pattern recognition means includes recognizing that a particular shopper has walked up and down a predetermined number of aisles without selecting an item for purchase.

9. The system according to claim 8, wherein said pattern recognition means further comprises recognizing continuous movement of a head of said particular shopper for a predetermined amount of time.

10. The system according to claim 1, wherein said area under surveillance includes a retail store, and said pattern recognition means further comprises recognizing continuous movement of a head of a particular shopper for a predetermined amount of time.

11. The system according to claim 8, wherein said pattern recognition means further comprises recognizing that said particular shopper has spent a predetermined amount of time in the store without selecting an item for purchase.

12. The system according to claim 1, wherein said area under surveillance includes a retail store, and said pattern recognition means further comprises recognizing that a particular shopper is carrying a bag.

13. The system according to claim 12, wherein said pattern recognition further comprises recognizing that said particular shopper is manipulating the bag.

14. The system according to claim 1, wherein said area under surveillance includes a retail store and a predetermined area outside of said store, and said pattern recognition means recognizing when a person is in the predetermined area outside of said store for a predetermined amount of time.

15. The system according to claim 1, wherein said area under surveillance includes a retail store, and said pattern recognition means recognizes that a particular shopper is wearing a coat when an outside temperature is greater than a predetermined value.

16. A method for surveillance and detection of suspicious behavior, said method comprising the steps of:
(a) observing behavior of a person in a predetermined area under surveillance;
(b) identifying whether the behavior observed in step (a) is associated with at least one of a plurality of predetermined suspicious behaviors by comparing the behavior observed with a plurality of predetermined behavioral patterns in a pattern recognition module;
(c) notifying security when the behavior observed has been identified as being associated with at least one of the plurality of predetermined behavioral patterns in the recognition module.

17. The method according to claim 16, further comprising: (d) increasing surveillance of said person whose behavior was observed in step (a) upon notification of security in step (c).

18. The method according to claim 16, wherein the behavior is observed in step (a) with cameras.

19. The method according to claim 16, wherein the behavior is observed in step (a) with sensors.

20. The method according to claim 19, wherein the sensors sense sounds.

21. The method according to claim 16, wherein the notifying includes providing warning signals to a monitoring site.

22. The method according to claim 16, wherein the notifying in step (a) includes providing an alert code selected from a plurality of alert codes indicating a severity of said one of the predetermined behavioral patterns recognized by the pattern recognition module.

23. The method according to claim 16, wherein at least one of the predetermined behavioral patterns in the recognition module includes recognizing when a plurality of people enter the area under surveillance as a single group, subsequently separate into sub-groups while moving through the area under surveillance, and subsequently re-emerging as said single group when leaving the store.

24. The method according to claim 16, wherein the area under surveillance is a retail store, and at least one of the predetermined behavioral patterns in said pattern recognition module includes recognizing when a particular shopper has walked up a down a predetermined number of aisles without selecting an item for purchase.

25. The method according to claim 16, wherein the area under surveillance is a retail store, and at least one of predetermined behavioral patterns in said pattern recognition module includes recognizing when a particular shopper has stayed in one aisle for a predetermined amount of time without selecting an item for purchase.

26. The method according to claim 16, wherein one of the predetermined behavioral patterns in said pattern recognition module includes recognizing movement of a head for a predetermined amount of time by a person in the area under surveillance.

27. The method according to claim 25, wherein one of the predetermined behavioral patterns in said pattern recognition module includes recognizing movement of a head for a predetermined amount of time by the particular shopper.

28. The method according to claim 16, wherein the area under surveillance is a retail store, and wherein one of the predetermined behavioral patterns in said pattern recognition module includes recognizing that a particular shopper is carrying a bag.

29. The method according to claim 28, wherein one of the predetermined behavioral patterns in said pattern recognition module includes recognizing that said particular shopping is manipulating the bag.

30. The method according to claim 16, wherein the area under surveillance is a store, and wherein one of the predetermined behavioral patterns in said pattern recognition module includes recognizing that a particular shopper is wearing a coat when an outside temperature is above a predetermined amount.

31. The method according to claim 16, wherein the area under surveillance comprises an interior portion and an exterior portion of a store, and wherein one of the predetermined behavioral patterns in said pattern recognition module includes recognizing when a particular person has been in the exterior portion of the store for a predetermined amount of time.
